(19) United States
(12) Patent Application Publication
(10) Pub. No.: US 2020/0385942 A1
(43) Pub. Date: Dec. 10, 2020

(54) TRAFFIC MONITORING ARRANGEMENT

(71) Applicant: JENOPTIK ROBOT GMBH, Monheim (DE)

(72) Inventors: Guenter HESSE, Goseck (DE); Jose GUILHERME, Irmtraut (DE); Tuncay BUEKRUE, Duisburg (DE)

(73) Assignee: JENOPTIK ROBOT GMBH, Monheim (DE)

(21) Appl. No.: 16/492,340

(22) PCT Filed: Mar. 7, 2018
(86) PCT No.: PCT/EP2018/055642

§ 371 Date: Sep. 9, 2019

(30) Foreign Application Priority Data
Mar. 8, 2017 (EP) 17000394.1

(51) Int. Cl. E01F 9/635; G08G 1/01; E01F 9/627

(52) U.S. Cl. CPC E01F 9/635; E01F 9/627; G08G 1/01

(57) ABSTRACT

A traffic monitoring arrangement with a housing having a first housing component and at least a second housing component, wherein the traffic monitoring arrangement comprises a flexible stop means, by which the first housing component and the second housing component are connected to each other. Furthermore, the traffic monitoring arrangement comprises at least one predetermined breaking point which, with respect to a local connection region provided by the second housing component, on which the flexible stop means is fixed, is located on a side of the traffic monitoring arrangement facing away from the first housing component.

This nonprovisional application is a National Stage of International Application No. PCT/EP2018/055642, which was filed on Mar. 7, 2018, and which claims priority to European Patent Application No. 17000394.1, which was filed in Europe on Mar. 8, 2017, and which are both herein incorporated by reference.

### BACKGROUND OF THE INVENTION

### Field of the Invention

The present invention relates to a traffic monitoring arrangement.

### Description of the Background Art

Traffic monitoring arrangements are known for the purpose of monitoring traffic, for example checking speed, measuring traffic density, managing tolls, etc., said traffic monitoring arrangements having at least one traffic monitoring installation, for example a vehicle speed measuring installation, an image recording installation, a vehicle identification and counting installation, a vehicle contour detection installation, a vehicle-to-infrastructure communication installation, etc., in such a manner that such a traffic monitoring installation for protection from weather influences is disposed, in particular fastened, in the interior space of a housing of the traffic monitoring arrangements.

In order for the housing to be landed in the ground at road level, the traffic monitoring arrangement typically comprises a foundation, for example a concrete foundation, which can be configured as a prefabricated concrete part.

Said housing in the case of the present invention is assembled from a plurality of housing components which, for example, are disposed on top of one another along a vertical axis that ends in the foundation. The invention relates to housings having two or more (for example up to twenty) housing components of this type, wherein the number of the housing components may correlate to the number of different traffic monitoring installations which, without limiting the generality, can be comprised by the traffic monitoring arrangement in such a manner that one of the traffic monitoring installations is in each case disposed in each or the plurality of the housing component.

The housing components are in particular connected to one another in a force-fitting manner, for example by means of screw connections.

The housing components, in a manner perpendicular to the vertical axis, can have a circular cross-section, a rectangular or hexagonal cross-section. To this extent, the housing components can be configured as a hollow cylinder, a hollow cuboid, or a hollow prism, preferably having upper and lower base areas that are at least in portions open, the openings of said upper and lower base areas permitting components (for example power supply lines and/or signal lines as well as connecting means) that extend across a plurality of housing components to be received.

The housing herein is typically fastened to the foundation, specifically in that a lower one of the housing components is fastened either directly to the foundation or by way of an intermediate piece by which the lower housing component, in particular along the vertical axis, is fastened indirectly to the foundation so as to be spaced apart from the foundation.

In the case of traffic monitoring arrangements of this type there is the problem that the connections between the housing components can buckle, in particular break, in the event of a vehicle impact on the housing, this having the effect that the housing in at least a partially singularized manner disintegrates into housing components or singularized groups of housing components that are still connected to one another. Such a disintegration is not predeterminable in a uniform manner because said disintegration depends on many conditions, for example: the type of vehicle (passenger motor vehicle, commercial vehicle), the speed of the vehicle, the impact angle of the vehicle, etc. This can lead to individual housing components under generally unknown accident circumstances exiting the housing composite in an uncontrolled manner and causing additional damage, in particular to uninvolved third parties.

### SUMMARY OF THE INVENTION

It is therefore an object of the present invention to provide a traffic monitoring arrangement in which an uncontrolled disintegration of the housing in the event of an impact is precluded, or the probability of an uncontrolled disintegration is at least significantly reduced.

The traffic monitoring arrangement according to the invention is characterized in that the first housing component and the second housing component are connected to one another by at least one flexible sling gear, and the traffic monitoring arrangement has at least one predetermined breaking point which in relation to a local connection region which is provided by the second housing component and to which the flexible sling gear is fastened is located on a side of the traffic monitoring arrangement that faces away from the first housing component.

This means in particular that the predetermined breaking point is located in a region of the traffic monitoring arrangement that is disposed on a side of the local connection region that faces away from the first housing component.

While the term sling gear has its origins in the sector of conveying and lifting technology and characterizes a connection between the lifting means and the load, or the load-receiving means, respectively, this term has nevertheless been chosen for this static arrangement of the sling gear in the traffic monitoring arrangement so as to define the type of the means which, independently of the use suggested by the term of the sling gear, is used in the invention and fulfils the purpose of securely connecting the first housing component to the second housing component.

Nevertheless, an analogy pertaining to conveying and lifting technology can nevertheless be seen in the invention, and this analogy additionally justifies the use of the term sling gear. In the event of an impact which results in the housing shearing off, in particular from a landing region of the traffic monitoring installation that is provided for arrangement in the ground, at the predetermined breaking point and in the case of screw connections breaking between directly adjacent housing components of the housing, the sling gear secures the cohesion of the first and second housing components which prior to the impact were disposed on top of one another in particular along a vertical axis that ends in the landing region. A tensile force that is typical for conveying and lifting herein acts on the sling gear substantially in the direction of the force of gravity. In this sense, in the case of a corresponding alignment of the housing after having sheared off from the landing region, that first or second housing component which is most remote from the soil can act as a lifting means, and that second or first housing component which is closest to the soil can act as a load.

By way of the invention it advantageously becomes possible for the damage that could be created on account of an impact of a vehicle on a traffic monitoring arrangement to be minimized or even avoided.

On the one hand, the predetermined breaking point in the event of an impact causes a defined shearing-off of the housing or of a main part of the housing which comprises at least one traffic monitoring installation, in particular from a landing region of the traffic monitoring arrangement, on account of which a deformation of the crash vehicle is limited. A landing region (for example a foundation or a landing portion of the housing) of the traffic monitoring arrangement according to the invention herein that is disposed in the ground cannot yield to a compressive force caused by the impact, on account of which a shear stress is configured between the impact region and the landing region, said shear stress leading to a fracture in the predetermined breaking point.

To this end, the predetermined breaking point can be configured in such a manner that said predetermined breaking point for structural reasons concentrates the shear stresses that arises and/or for material reasons on account of a locally reduced shear strength acts as a shear region.

On the other hand, the flexible sling gear causes the cohesion of the first and second housing components and protects uninvolved persons from housing components and/or the contents thereof that are ejected in an uncontrolled manner. Since the flexible sling gear in relation to the predetermined breaking point is fastened to a side of the housing that faces away from the foundation it is advantageously guaranteed that that construction element that prevents the uncontrolled singularization of the housing components does not suppress the desired shearing-off of the housing from the landing region.

The traffic monitoring arrangement according to the invention preferably has a landing region for landing the traffic monitoring arrangement in the ground, wherein the landing region in relation to the predetermined breaking point is disposed on a side that faces away from the local connection region.

For example, said landing region is provided by at least one foundation for landing the housing in the ground, in particular in the ground at road level.

Less preferably, the housing per se is provided for landing in the ground, wherein a landing portion of the housing, with the exception of at least the first housing component, is provided for arrangement in the ground and wherein the predetermined breaking point is also not provided for arrangement in the ground.

For example, the housing has at least one landing component which is disposed on a side of the second housing component, preferably fastened to the second housing component, that faces away from the first housing component, and is provided for arrangement in the ground, wherein the predetermined breaking point of the second housing component, or is disposed in a region of the landing component that is not provided for arrangement in the ground.

The traffic monitoring arrangement according to the invention has in particular a traffic monitoring installation, wherein the housing according to the invention for receiving the at least one traffic monitoring installation is configured in the housing, in particular in an interior space of the housing, in particular outside the afore-mentioned landing region.

At least one traffic monitoring installation is in particular comprised by the first housing component, by the second housing component, or by an intermediary housing component of the housing that is disposed between the first housing component and the second housing component.

Examples of traffic monitoring installations which are comprised by the first housing component, by the second housing component, and/or by one or a plurality of intermediary housing component(s) of the housing that is/are disposed between the first housing component and the second housing component include a vehicle speed measuring installation, an image recording installation, a vehicle identification and counting installation, a vehicle contour detection installation, a vehicle-to-infrastructure communication installation.

The first housing component and the second housing component belong in particular to housing components of the housing that are disposed on top of one another on a common vertical axis of the housing. Said vertical axis ends in particular in a landing region of the traffic monitoring arrangement, for example a foundation of the traffic monitoring arrangement.

Such an arrangement of the first housing component and of the second housing component is indeed preferable for reasons of production, space, and stability, but is nevertheless not mandatory. Instead of the first and/or the second housing component, a third and/or fourth housing component of the housing can thus be disposed on the vertical axis of the traffic monitoring. Furthermore, a vertical axis that is common to the first and the second housing component does also not have to end in a landing region of the traffic monitoring arrangement because said landing region can be located outside the vertical axis.

The local connection region in the direction of said vertical axis is preferably spaced apart from said landing region by the at least one predetermined breaking point.

The first housing component and the second housing component at least in portions enclose in particular an interior space of the housing.

The first housing component in relation to the second housing component herein is in particular disposed on a side of the second housing component that faces away from a landing region of the traffic monitoring arrangement (for example a foundation).

The traffic monitoring arrangement preferably has a foundation, and the housing has a lower housing component which is fastened directly to a landing component of the traffic monitoring arrangement (for example a foundation of the traffic monitoring arrangement or a landing component of the housing).

Alternatively, the traffic monitoring arrangement has at least one intermediate piece which is disposed on a side of the second housing component, preferably is fastened to the second housing component, that faces away from the first housing component and which can be, but does not have to be, a housing component of the housing. A lower housing component of the housing herein can be fastened indirectly to the landing component so as to be spaced apart from the landing component of the traffic monitoring arrangement by the intermediate piece.

The second connection region herein is in particular spaced apart from a landing region of the traffic monitoring arrangement that is provided for landing in the ground (landing portion or landing component of the housing or foundation of the traffic monitoring arrangement) by the at least one predetermined breaking point. The second connection region in the direction of a vertical axis which ends in the landing region and on which the first housing component and the second housing component are disposed is in particular spaced apart from the landing region by the at least one predetermined breaking point.

If the traffic monitoring arrangement has said intermediate piece, the predetermined breaking point is thus preferably provided by said intermediate piece.

Independently of the existence of said intermediate piece, the predetermined breaking point can instead be provided by a predetermined breaking region of the second housing component, wherein such a predetermined breaking region is disposed between the second connection region and a fastening region of the second housing component that is fastened to the foundation.

Embodiments of the traffic monitoring arrangement provide a landing region for landing the traffic monitoring arrangement in the ground, wherein the landing region is provided by a landing component which is configured as a foundation of the traffic monitoring arrangement or a landing component of the housing; the first housing component and the second housing component belong to housing components of the housing that are disposed on top of one another on a common vertical axis of the housing that ends in the landing component, the first housing component in relation to the second housing component being disposed on the side of the second housing component that faces away from the landing component; the second housing component is fastened directly or indirectly, that is to say so as to be spaced apart from the landing component by at least one intermediate piece, to the landing component; and the local connection region in the direction of the vertical axis is spaced apart from the landing component by the at least one predetermined breaking point, wherein the predetermined breaking point is provided by the intermediate piece, or a predetermined breaking region of the second housing component, said predetermined breaking region being disposed between the local connection region and a fastening region of the second housing component that is fastened to the landing component.

The invention provides in particular a traffic monitoring arrangement having at least one traffic monitoring installation, at least one housing for receiving the at least one traffic monitoring installation in the housing, and at least one foundation for landing the housing in the ground, wherein the housing has a plurality of housing components which are disposed on top of one another along a vertical axis that ends in the foundation and which at least in portions enclose at least one interior space of the housing, and a lower one of the housing components is fastened directly or indirectly, that is to say so as to be spaced apart from the foundation by at least one intermediate piece, to the foundation, wherein the traffic monitoring arrangement is characterized by at least one flexible sling gear having a first connection portion which by way of at least one first connection location is fastened to a first connection region of a first of the housing components, and at least one second connection portion which by way of at least one second connection location is fastened to a second connection region of a second of the housing components, wherein the first housing component in relation to the second housing component is disposed on the side of the second housing component that faces away from the foundation, and the second connection region in the direction of the vertical axis is spaced apart from the foundation by at least one predetermined breaking point, wherein the predetermined breaking point is provided by the intermediate piece or a predetermined breaking region of the second housing component, said predetermined breaking region being disposed between the second connection region and a fastening region of the second housing component that is fastened to the foundation.

Said intermediate piece which can serve as the predetermined breaking point does not necessarily have to be a housing component of the housing. Said intermediate piece can provide an interior space that is separate from that housing interior space that is provided conjointly by the first housing component and the second housing component, or else be configured entirely without an interior space. Said intermediate piece can also be formed by a porous structure having a multiplicity of cavities. Alternatively, the intermediate piece can provide part of the interior space of the housing which in part is also provided by the first housing component and the second housing component. The intermediate piece can thus be considered to be part of the housing.

The flexible sling gear according to the invention is is in particular understood to be a sling gear having a structure-related flexibility. Such a structure-related flexibility is in particular provided by a plurality of components (for example fibers, links, see below) of the sling gear which form the structure of the sling gear and which are in particular connected to one another in a form-fitting manner such that the flexibility of the sling gear is guaranteed.

In this sense, a textile sling gear is a flexible sling gear, for example.

Exemplary representatives of a flexible sling gear include a lashing, a chain, and a belt webbing. A lashing herein is in particular understood to be a flexible elongate sling gear of a substantially round cross-section that has been produced by twisting or braiding a plurality of elongate fibers, threads, or yarns, etc., in particular a steel cable or a braided line. A chain, for example, is a succession of movable links that are interlinked or connected by joints. A belt webbing, for example, is a flexible elongate sling gear of a substantially rectangular cross-section that has been produced by interweaving fibers and/or wires. A belt webbing, with or without being wound about the longitudinal axis, can be refined so as to form a sling by way of an annular closure.

The flexible sling gear has in particular a first connection portion which by way of at least one first connection location is fastened to a first connection region of the first housing component, and at least one second connection portion which by way of at least one second connection location is fastened to the local connection region as the second connection region of the second housing component.

The first connection portion herein can in particular form a first end portion of the flexible sling gear, and/or the second connection portion can form a second end portion of the flexible sling gear.

The first connection portion of the flexible sling gear at least in portions is preferably disposed in the first housing component or outside the first housing component in an alignment of the first housing component, said alignment, proceeding from the first housing component, in the direction facing away from the foundation extending so as to be perpendicular to the vertical axis and/or parallel to the vertical axis.

The second connection portion at least in portions is preferably disposed in the second housing component or outside the second housing component in an alignment of the second housing component, said alignment, proceeding from the second housing component, extending so as to be perpendicular to the vertical axis.

Other arrangements in which said first and/or second connection portions are in each case disposed so as to be spaced apart from the first and/or the second connection region so far that such a specific arrangement is no longer present are however also possible.

The flexible sling gear preferably has at least one first coupling portion by way of which the first connection portion is coupled to the second connection portion.

A longitudinal axis of the first coupling portion herein is preferably at least in portions aligned so as to be parallel to the vertical axis. While this is indeed material-saving and space-saving in the sense of the shortest span from the first to the second connection portion, this is nevertheless not mandatory. Alternatively or additionally, the first coupling portion, for example, can at least in portions run in the shape of a spiral on the cylindrical internal or external walls of the housing components, in particular between intermediary housing components that are disposed between the first and second housing components, so as to be concentric with the vertical axis.

The housing preferably has at least one intermediary housing component which on the vertical axis is disposed between the first housing component and the second housing component, comprises at least one traffic monitoring installation, and by way of which the first housing component is connected to the second housing component, wherein the first coupling portion at least in portions is disposed in the intermediary housing component or outside the intermediary housing component in an alignment of the intermediary housing component that, proceeding from the intermediary housing component, extends so as to be perpendicular to the vertical axis.

In general, the housing in the case of embodiments of the traffic monitoring arrangement according to the invention has at least one intermediary housing component which, on a vertical axis of the traffic monitoring arrangement on which the first housing component and the second housing component are also disposed, is disposed between the first housing component and the second housing component, the first housing component being connected to the second housing component by way of said intermediary housing component. The flexible sling gear herein in the intermediary housing component or outside the intermediary housing component is preferably at least in portions disposed in an alignment of the intermediate housing component which, proceeding from the intermediary housing component, extends so as to be perpendicular to the vertical axis.

The intermediary housing component preferably comprises at least one traffic monitoring installation.

The first connection location is preferably configured as a first coupling which is provided by a first coupling portion of the first housing component or by a first coupling component which is made independently of the first housing component and which is, in particular releasably, fastened to the first housing component.

Such a first coupling portion forms in particular a materially integral unit with the first connection region of the first housing component. For releasably fastening such a first coupling component to the first housing component, at least one fastening means engages in particular in the first connection region of the first housing component.

A connection between the first connection portion and the first connection region can be established in a simple and reliable manner by way of a configuration of the first connection location of this type, wherein the first connection portion preferably latches in a first coupling element in which the first coupling is also latched. Such a first coupling element is, for example, a carabiner or a shackle.

Alternatively or additionally, the second connection location is preferably configured as a coupling which is provided by a coupling portion of the second housing component or by a coupling component which is made independently of the second housing component and which is, in particular releasably, fastened to the second housing component.

Such a second coupling portion forms in particular a materially integral unit with the second connection region of the second housing component. For releasably fastening such a second coupling component to the second housing component, at least one fastening means engages in particular in the second connection region of the second housing component.

A connection between the second connection portion and the second connection region can be established in a simple and reliable manner by way of a configuration of the second connection location of this type, wherein the second connection portion is preferably latched in a second coupling element in which the second coupling is also latched. Such a second coupling element is, for example, a carabiner or a shackle.

In one preferred embodiment, of the flexible sling gear at least the first connection portion and the second connection portion and, in as far as present, also the first coupling portion are disposed in the interior space of the housing, wherein the interior space in turn at least in portions is the limited by interior walls of the housing components.

In one less preferable embodiment, of the flexible sling gear at least the first connection portion and the second connection portion and, in as far as present, also the first coupling portion are disposed outside the housing.

The first connection region is preferably formed by at least one first housing wall portion of the first housing component. Said first housing wall portion is preferably comprised by a housing wall (for example a housing shell in the case of a hollow-cylindrical shape of the first housing component) that is aligned so as to be parallel to the vertical axis or by a cover plate of the first housing component that is aligned so as to be normal to the vertical axis.

The second connection region is preferably formed by a second housing wall portion of the second housing component. Said second housing wall portion is preferably comprised by a housing wall (for example a housing shell in the case of a hollow-cylindrical shape of the second housing component) that is aligned so as to be parallel to the vertical axis.

The second housing component comprises in particular at least one housing wall that is aligned so as to be parallel to the vertical axis. Said housing wall in the case of the hollow-cylindrical shape of the second housing component can be provided by a housing shell which has an external shell face that is concentric with the vertical axis as well as an internal shell face which in portions delimits the interior space of the housing. In the case of a hollow-cuboidal shape of the second housing component, the housing wall can be provided by each side wall of the hollow cuboid that is correspondingly aligned so as to be parallel to the vertical axis.

The fastening region of the second housing component herein is preferably provided by a base plate which bears on a bearing face of the foundation and which is connected to the at least one housing wall.

This base plate can be closed, can have openings for fastening to the foundation, for conducting current, or for wire-bound communications, or be configured as an internal collar and/or external collar.

The predetermined breaking region of the second housing component herein is preferably provided by a first housing wall portion of the at least one housing wall that, in a manner parallel to the vertical axis, is spaced apart from the bearing face of the foundation by at least the thickness of the base plate in the connector region of the latter to the at least one housing wall.

The second connection region of the second housing component herein is preferably provided by a second housing wall portion of the at least one housing wall that in the direction facing away from the foundation adjoins the first housing wall portion in a manner parallel to the vertical axis. Moreover, said second housing wall portion can include the second connection location or means for fastening the second connection location.

The second housing component preferably corresponds to said lower housing component. A particularly efficient and cost-effective use of the flexible sling gear is enabled by way of this embodiment.

The second housing component is less preferably not the lower housing component. In order for an effect according to the invention to be achieved which includes the lower housing component, it in this case necessary the the lower housing component is connected to the second housing component by way of a further flexible sling gear. The above explanations pertaining to the configuration of a second housing component which is fastened directly to a foundation of the traffic monitoring arrangement can in this case be applied to the lower housing component.

The first housing component is preferably that uppermost of all housing components of the housing that is disposed so as to be spaced apart farthest from the foundation. A particularly efficient and cost-effective use of the flexible sling gear is enabled by way of this embodiment.

The first housing component is less preferably not that uppermost of all housing components of the housing that is disposed so as to be spaced apart farthest from the foundation. In order for an effect according to the invention to be achieved which includes the lower housing component, it is in this case necessary for the uppermost housing component as a third housing component to be connected to the first housing component by way of a further flexible sling gear.

The traffic monitoring arrangement according to the invention can thus be characterized in that the housing thereof has a third housing component which is disposed on a side of the first housing component that faces away from the second housing component, and in that said traffic monitoring arrangement has a plurality of flexible sling gears of which a first flexible sling gear is said flexible sling gear by way of which the first housing component and the second housing component are connected to one another, and a second flexible sling gear is a further flexible sling gear by way of which the first housing component and the third housing component are connected to one another.

The first housing component, the second housing component, and the third housing component belong in particular to housing components of the housing which are disposed on top of one another on a common vertical axis of the housing. Said vertical axis ends in particular in a landing region of the traffic monitoring arrangement, for example a foundation of the traffic monitoring arrangement, or a landing component of the housing.

However, the second housing component is particularly preferably the lower housing component, and the first housing component is that of all housing components of the housing that is disposed so as to be spaced apart farthest from the foundation. A particularly efficient and cost-effective use of only a single flexible sling gear is guaranteed by way of this embodiment.

The traffic monitoring arrangement according to the invention can nevertheless be characterized by a plurality of flexible sling gears of which a first flexible sling gear is said flexible sling gear by way of which the first housing component and the second housing component are connected to one another, and a second flexible sling gear is a further flexible sling gear by way of which the first housing component and the second housing component are likewise connected to one another.

The traffic monitoring arrangement according to the invention is preferably characterized in that the flexible sling gear has at least one tensile force limiter, or is connected to the first housing component and/or the second housing component by way of at least one tensile force limiter.

The flexible sling gear has in particular a first connection portion which by way of at least one first connection location is fastened to a first connection region of the first housing component; at least one second connection portion which by way of at least one second connection location is fastened to the local connection region as the second connection region of the second housing component; and optionally at least one first coupling portion by way of which the first connection portion is coupled to the second connection portion, wherein at least one of the portions of the first connection portion, the second connection portion and the optional first coupling portion, a first connecting means by way of which the first connection portion is fastened to the first connection location, a second connecting means by way of which the second connection portion is fastened to the second connection location, the first connection location and/or the second connection location, forms or includes a tensile force limiter.

For example, in the case of the traffic monitoring arrangement having a landing region for landing the traffic monitoring arrangement in the ground, and the first housing component and the second housing component being disposed on a common vertical axis of the traffic monitoring arrangement that ends in the landing region, the first/the second connection location can at least in part be formed by a metallic plate which has a first plate portion which is fastened to the first/the second connection region, and a second plate portion to which the first/the second connection portion is fastened, wherein the metallic plate acts as the tensile force limiter in that said metallic plate is configured and in relation to the vertical axis is oriented in such a manner that a tensile force that is exerted on the second plate portion so as to be at least partially parallel to the vertical axis deflects the second plate portion in relation to the first plate portion in a manner at least partially parallel to the vertical axis.

The metallic plate is in particular configured and in relation to the vertical axis oriented in such a manner that a tensile force that is exerted on the second plate portion so as to be at least partially parallel to the vertical axis and is transmitted by the first/the second connection portion deflects the second plate portion in relation to the first plate portion in a manner at least partially parallel to the vertical axis.

In the simplest case, such a plate is provided by a metal sheet that yields in the direction of tensile stress, for example a metal sheet that is capable of tearing and or flexing.

In as far as the flexible sling gear has a first connection portion which by way of at least one first connection location is fastened to a first connection region of the first housing component, and at least one second connection portion which by way of at least one second connection location is fastened to the local connection region as the second connection region of the second housing component, the first connection location can be formed by a first connection element (single hook or double hook, opening, deck plate, eye bolt or eyelet bolt, threaded yoke with securing pin, etc.) that is fastened to the first connection region or is provided by the first connection region, and/or the second connection location can be formed by a second connection element (single hook or double hook, opening, deck plate, eye bolt or eyelet bolt, threaded yoke with securing pin, etc.) that is fastened to the second connection region or is provided by the second connection region.

In as far as the flexible sling gear has a first connection portion which by way of at least one first connection location is fastened to a first connection region of the first housing component, and at least one second connection portion which by way of at least one second connection location is fastened to the local connection region as the second connection region of the second housing component, the first connection portion can have a loop or an eye splice, wherein the first connection portion is fastened to the first connection location by means of the loop or the eye splice, and/or the second connection portion have a loop or an eye splice, wherein the second connection portion is fastened to the second connection location by means of the loop or the eye splice.

The loop herein can be formed by knots (reef knots), a hitch (cow hitch, clove hitch), etc.; the loop or the eye splice can comprise a cringle.

In as far as the flexible sling gear has a first connection portion which by way of at least one first connection location is fastened to a first connection region of the first housing component, and at least one second connection portion which by way of at least one second connection location is fastened to the local connection region as the second connection region of the second housing component, the first connection portion can be fastened to the first connection location by way of a first connecting means (carabiner, shackle, toggle, end sleeve, etc.), and/or the second connection portion is fastened to the first connection location by way of a second connecting means (carabiner, shackle, toggle, end sleeve, etc.).

The flexible sling gear according to the invention is preferably provided by a lashing which has a plurality of elongate fibers that are intertwined by twisting or braiding.

Such a lashing is preferably provided by a braided line, preferably having a diameter of 8 to 15 mm, which has fibers from plastics material (in particular from polyethylene (HPPE, Dyneema®), polyaramid (Kevlar®), PTFE, PBO (Zylon®), and/or thermotropic polymer (Vectran®), etc.), wherein the braided line can have a core and a jacket which has fibers from different types of said materials. The tear strength of the lashing is preferably more than 10 kN and less than 1000 kN. The tear strength of said braided line is particularly preferably in the range from 50 kN to 200 kN.

The flexible sling gear according to the invention is less preferably provided by a chain. A chain of this type preferably has links from stainless steel.

In the case of the traffic monitoring arrangement having a landing region for landing the traffic monitoring arrangement in the ground, and the first housing component and the second housing component being disposed on a common vertical axis of the traffic monitoring arrangement that ends in the landing region, at least one first sub-portion of the flexible sling gear that is disposed in a first intermediary housing component which is disposed between the first housing component and the second housing component is preferably disposed within an alignment, running parallel to the vertical axis, of at least one second sub-portion of the flexible sling gear that is disposed in a second intermediary housing component which is disposed between the first housing component and the second housing component.

On the other hand, in the case of the traffic monitoring arrangement having a landing region for landing the traffic monitoring arrangement in the ground, and the first housing component and the second housing component being disposed on a common vertical axis of the traffic monitoring arrangement that ends in the landing region, it can also be advantageous for at least one first sub-portion of the flexible sling gear that is disposed in a first intermediary housing component which is disposed between the first housing component and the second housing component, to be disposed outside an alignment, running parallel to the vertical axis, of at least one second sub-portion of the flexible sling gear that is disposed in a second intermediary housing component which is disposed between the first housing component and the second housing component, specifically when a first traffic monitoring installation is comprised by the first intermediary housing component and/or a second/first traffic monitoring installation is comprised by the second intermediary housing component. In this case, the flexible sling gear, on account of the flexibility thereof, permits said flexible sling gear to be guided about the respective first/second traffic monitoring installation where there is space therefor in the respective first/second intermediary housing component.

For example, the first sub-portion and the second sub-portion herein can be comprised by a first coupling portion of the flexible sling gear by way of which a first connection portion of the flexible sling gear which by way of at least one first connection location is fastened to a first connection region of the first housing component, is coupled to a second connection portion of the flexible sling gear which by way of at least one second connection location is fastened to the local connection region from the second connection region of the second housing component.

Embodiments of the traffic monitoring arrangement according to the invention a plurality of different first sub-portions of the flexible sling gear that are separated from one another by different second sub-portions of the flexible sling gear that are disposed in the first housing component and the second housing component and/or fastened to said first housing component and said second housing component, are disposed in one and the same intermediary housing component which is disposed between the first housing component and the second housing component.

Embodiments of this type relate to traffic monitoring arrangements according to the invention in which the flexible sling gear is disposed within the housing.

In an equivalent manner, this provision can be applied to embodiments of respective traffic monitoring arrangements according to the invention in which, less preferably, the flexible sling gear is disposed outside the housing. To this end, it is necessary for the relative spaces for locating said sub-portions to be defined by means of the mutual arrangement of the housing components.

Assuming the above, embodiments of the traffic monitoring arrangement according to the invention are characterized in that the housing has at least one intermediary housing component which, on a vertical axis of the traffic monitoring arrangement on which the first housing component and the second housing component are also disposed, is disposed between the first housing component and the second housing component, the first housing component being connected to the second housing component by way of said intermediary component, wherein a plurality of different first sub-portions of the flexible sling gear that are separated from one another by different second sub-portions of the flexible sling gear that are disposed in alignments, extending perpendicularly to the vertical axis, of the first housing component and of the second housing component, are disposed in an alignment, extending perpendicularly to the vertical axis, of one and the same intermediary housing component.

It can in particular be provided that the flexible sling gear has a first connection portion which by way of at least one first connection location is fastened to a first connection region of the first housing component, a second connection portion which by way of at least one second connection location is fastened to the local connection region as the second connection region of the second housing component, a first coupling portion by way of which the first connection portion is coupled to the second connection portion, at least one third connection portion which by way of a the first, the second, or a third connection location is fastened to the first connection region, to the second connection region, or to a third connection region of the first housing component or of the second housing component, as well as at least one second coupling portion by way of which the first connection portion or the second connection portion is coupled to the third connection portion, wherein the first coupling portion and the second coupling portion are disposed in one and the same intermediary housing component which is disposed between the first housing component and the second housing component.

The first connection portion herein can in particular form a first end portion of the flexible sling gear, or the second connection portion can form a first end portion of the flexible sling gear, wherein the third connection portion forms a second end portion of the flexible sling gear, and the second coupling portion couples that first or second connection portion that does not form the first end portion to the third connection portion.

In the case of the first connection portion not forming the first end portion, the first connection portion by way of a plurality of first connection locations can be fastened to a plurality of first connection regions of the first housing component, and in the case of the second connection portion not forming the first end portion, the second connection portion by way of a plurality of second connection locations can be fastened to a plurality of second connection regions of the second housing component.

The predetermined breaking point can in particular be provided by a first wall portion of a housing component, the first thickness of said first wall portion being less than the second thickness of a second wall portion of the same or of another housing component, wherein the second wall portion in relation to the first wall portion is disposed on a side of the housing that faces away from the local connection region.

This means in particular that the second wall portion is located in a region of the housing that is disposed on the side of the first wall portion that faces away from the local connection region.

The directions of the first thickness and of the second thickness extend in particular perpendicularly to a vertical axis of the traffic monitoring arrangement on which the first housing component and the second housing component are disposed. Said vertical axis preferably ends in a landing region of the traffic monitoring arrangement for landing the traffic monitoring arrangement in the ground.

In as far as the predetermined breaking point is provided by a predetermined breaking region of the second housing component, said predetermined breaking region being disposed between the local connection region and a fastening region of the second housing component, said fastening region being fastened to a landing region of the traffic monitoring arrangement that is configured as a landing component (foundation of the traffic monitoring arrangement or landing component of the housing), the predetermined breaking region in the direction perpendicular to the vertical axis has a first thickness of a first wall portion of the second housing component which is less than the second thickness of a second wall portion of the second housing component that contributes to the fastening region or comprises the latter.

In as far as the fastening region comprises a base plate of the second housing component which bears on a bearing face of the landing component and, proceeding from a housing wall of the second housing component, extends perpendicularly to the vertical axis, the extent of the base plate in the direction perpendicular to the vertical axis also belongs to said second thickness of the second wall portion.

In as far as the predetermined breaking point is provided by a predetermined breaking region of the second housing component, said predetermined breaking region being disposed between the local connection region and a fastening region of the second housing component, said fastening region being fastened to a landing region of the traffic monitoring arrangement that is configured as a landing component (foundation of the traffic monitoring arrangement or landing component of the housing) and comprising a base plate of the second housing component which bears on a bearing face of the landing component and, proceeding from a housing wall of the second housing component, extends perpendicularly to the vertical axis, the predetermined breaking region is preferably spaced apart from the bearing face by at least a distance which corresponds to the extent of the base plate parallel to the vertical axis at the location where the base plate transitions to the housing wall.

Alternatively or additionally, the predetermined breaking point can be provided by a first material in a first wall portion of a housing component, the first shear strength of said material being less than the second shear strength of a second material a a second wall portion of the same or of another housing component, wherein the second wall portion in relation to the first wall portion is disposed on a side of the housing that faces away from the local connection region.

The first and the second material can in particular differ from one another on account of different microstructures of a material that in terms of the chemical composition is identical.

Alternatively or additionally, the predetermined breaking point can be provided by a first material in a first wall portion of a housing component, the first porosity of said material being greater than the second porosity of a second material a a second wall portion of the same or of another housing component, wherein the second wall portion in relation to the first wall portion is disposed on a side of the housing that faces away from the local connection region.

Alternatively or additionally, the traffic monitoring arrangement has a landing region for landing the traffic monitoring arrangement in the ground, wherein the landing region is provided by a landing component which is configured as a foundation of the traffic monitoring arrangement or a landing component of the housing, the first housing component and the second housing component belong to housing components of the housing that are disposed on top of one another on a common vertical axis of the housing that ends in the landing component, the first housing component in relation to the second housing component being disposed on the side of the second housing component that faces away from the landing component, and wherein the predetermined breaking point is provided by an intermediate piece which on the vertical axis is disposed between the second housing component and the landing component.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the schematic cross-sectional view of a first exemplary embodiment of the traffic monitoring arrangement according to the invention;

FIG. 2 shows the schematic cross-sectional view of a second exemplary embodiment of the traffic monitoring arrangement according to the invention;

FIG. 2′ shows the schematic cross-sectional view of FIG. 2 in fragments;

FIG. 2a shows the perspective view of a tensile force limiter used in the second exemplary embodiment of the traffic monitoring arrangement according to the invention;

FIG. 3 shows the schematic cross-sectional view of a third exemplary embodiment of the traffic monitoring arrangement according to the invention;

FIG. 4 shows the schematic cross-sectional view of a fourth exemplary embodiment of the traffic monitoring arrangement according to the invention;

FIG. 5 shows the schematic cross-sectional view of a fifth exemplary embodiment of the traffic monitoring arrangement according to the invention; and

FIG. 6 shows the schematic external view of a sixth exemplary embodiment of the traffic monitoring arrangement according to the invention.

### DETAILED DESCRIPTION

### First Exemplary Embodiment

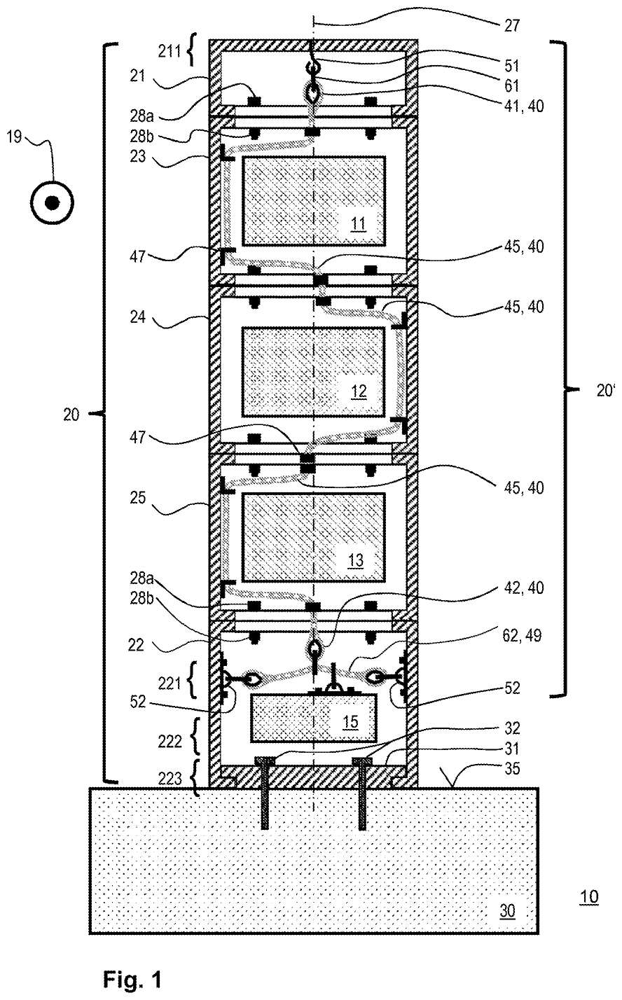

FIG. 1 shows the schematic cross-sectional view along the vertical axis 27 of the housing 20 of a traffic monitoring arrangement 10 according to the invention and according to a first exemplary embodiment, wherein the cross-sectional plane lies so as to be perpendicular to the detection direction of the traffic monitoring installations 11, 12, and 13, this being visualized by means of the detection direction symbol 19 which symbolizes a detection direction that is directed out of the illustration plane. The detection direction is ideally oriented so as to be anti-parallel to the traffic direction. However, since the invention is a traffic monitoring arrangement 10 that is configured for being landed in the ground at road level, the detection direction typically deviates from the counter direction of the traffic by 10° to 45°. The housing 20 is fastened to a foundation 30 which is landed in the ground at road level, and has five housing components 21, 22, 23, 24, and 25 which are disposed on top of one another along the vertical axis 27. The vertical axis 27 is aligned so as to be perpendicular to the upper side 35 of the foundation 30 that faces the housing 20. Said foundation upper side 35 provides a bearing face 35 for the housing 20.

A housing component referred to as the first housing component 21 also is considered as the uppermost housing component in the sense that the first housing component 21 of all housing components 21, 22, 23, 24, and 25 is that housing component 21 which along the vertical axis 27 is disposed so as to be the most remote from the foundation 30.

A housing component referred to as the second housing component 22 also is considered as the lowermost housing component in the sense that the second housing component 22 of all housing components 21, 22, 23, 24, and 25 is that housing component 22 which along the vertical axis 27 is disposed so as to be closest to the foundation 30.

The housing components 21, 22, 23, 24, and 25 are configured in the shape of circular hollow cylinders, the walls thereof that provide shell faces in each case enclosing in portions the interior space of the housing 20. Said walls on the lower sides thereof that face the foundation 30 and on the upper sides thereof that face away from the foundation have in each case an inwardly directed collar that is oriented so as to be orthogonal to the wall, the respective external side of said collar providing a flange face for the force-fitting connection between two directly adjacent housing components 21 and 23, 23 and 24, 24 and 25, as well as 25 and 22, said force-fitting connection being effected by threaded bolts 28a and nuts 28b.

Exceptions are, on the one hand, the upper side of the upper (first) housing component 21, said upper side being configured as a closed cover plate, and, on the other hand, the (lower-side) collar of the lower side of the lower (second) housing component 22, the external side of said collar serving as a support face for bearing on the bearing face 35 of the foundation 30. The second housing component 22 herein, by means of a fastening plate 31 and fastening screws 32 which penetrate the fastening plate 31 and engage in a force-fitting manner in the foundation 30, is fastened directly to the foundation 30 in that the fastening plate 31 in the peripheral region thereof bears on the internal side of the lower-side collar of the second housing component 22.

The foundation 30 is largely composed of concrete and can have a stainless-steel insert (not illustrated) which provides a particularly planar bearing face 35 and internal threads for the reliable engagement of the fastening screws 32. The foundation 30 can furthermore have at least one duct (likewise not illustrated) having an inlet opening that faces the housing 20 and an outlet opening that faces away from the housing 20 by way of which power supply and/or signal lines (likewise not illustrated) are guided into the housing 20, preferably by way of a breakthrough in the fastening plate 31, said breakthrough likewise not been illustrated.

One traffic monitoring installation 11, 12, and 13 is in each case disposed in the intermediary housing components 23, 24, and 25 that are disposed between the first housing component 21 and the second housing component 22. A vehicle contour detection installation 11 (for example a LIDAR, a RADAR, a time-of-flight camera, or a stereo camera) is fastened in the interior space of the housing component 23 (for example on the internal side of the wall of the housing component 23) in the second uppermost housing component 23; an image recording installation 12 (for example a traffic monitoring camera) is fastened in the interior space of the housing component 24 (for example on the internal side of the wall of the housing component 24) in the third uppermost housing component 24; a vehicle-to-infrastructure communication installation 13 (for example a DSRC (Dedicated Short Range Communication) installation) for the radio-supported collection of data of a passing vehicle is fastened in the interior space of the housing component 25 (for example on the internal side of the wall of the housing component 25) in the second lowermost housing component 25.

The housing component walls herein can in portions be configured as a door, a flap, or a loading front of a drawer, wherein the traffic monitoring installations 11, 12, and 13, are in each case fastened to the corresponding door, flap, or drawer, such that a good accessibility to the respective traffic monitoring installation is provided by way of the door, flap, or loading front when a housing component is opened.

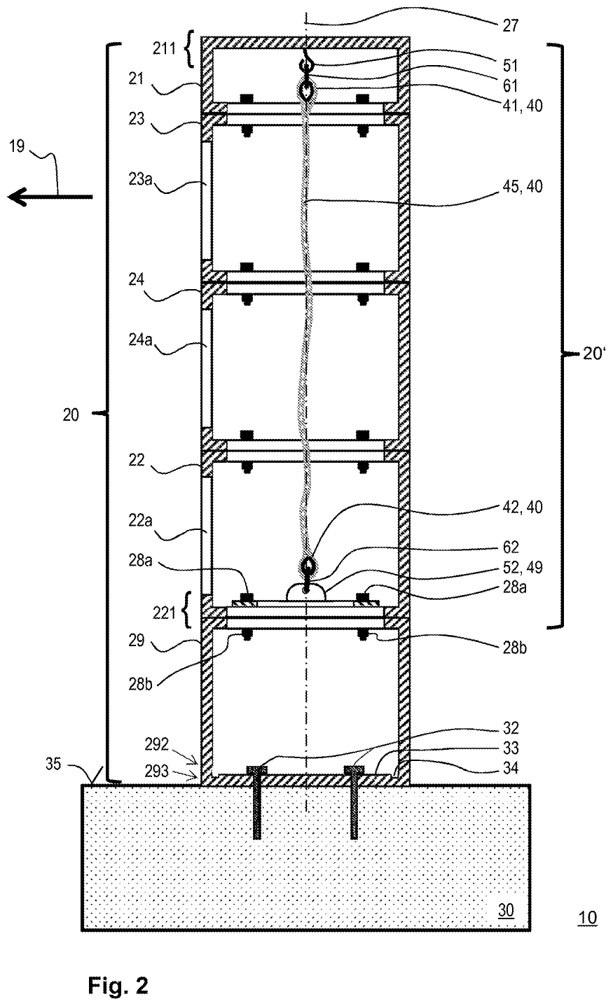

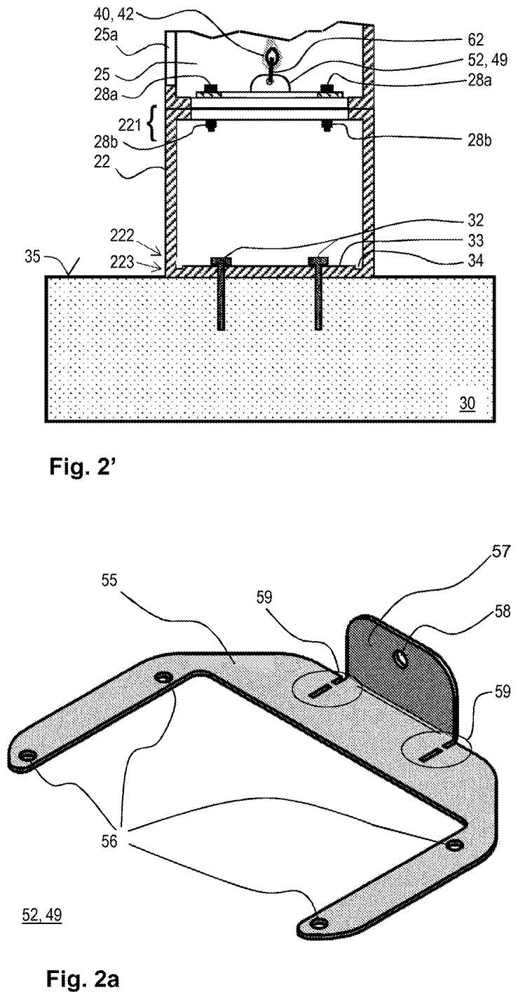

The intermediary housing components 23, 24, and 25, have openings (not illustrated in this view perspective) which permit the detection of in particular optical and/or electromagnetic signals of the vehicle by the traffic monitoring installations 11, 12, and 13 and which are illustrated, for example, in FIG. 2 using the reference signs 23a and 24a, and in FIG. 2′ using the reference sign 25a. Said housing openings can be closed by material, for example window glass, that is permeable to the optical and/or electromagnetic signals, so as to protect the interior space of the housing 20, and thus also the traffic monitoring installations 11, 12, and 13, from the weather.

A data processing installation 15 which is configured for receiving and processing measured values of the traffic monitoring installation 11, 12, and/or 13, for example a vehicle contour of a passing vehicle detected by the vehicle contour detection installation 11, an image recording of the passing vehicle detected by the image recording installation 12, and/or a dataset detected by the DSRC installation that represents a vehicle state of the passing vehicle, and for outputting the result of said processing to a traffic monitoring vehicle and/or a traffic monitoring center, preferably by way of a WLAN or mobile wireless communication installation (not illustrated) that is comprised by the traffic monitoring arrangement, is fastened in the interior space of the lower, second housing component 22.

The housing 20 comprises a lashing, configured as a braided line 40, as the flexible sling gear according to the invention, said sling gear being completely disposed in the interior space of the housing. The braided line 40 has a 32-ply braided jacket of fibers from Vectran®, and a 12-ply braided core of fibers from Dyneema®, and possesses a diameter of 12 mm. Said braided line 40 has a first connection portion 41 having a cringle that is spliced into a lashing eye, said cringle being disposed in the first, upper housing component 21. Said braided line 40 furthermore has a second connection portion 42 having a cringle that is spliced into a lashing eye, said cringle being disposed in the lower, second housing component 21.

The braided line 40 finally has a first coupling portion 45 by way of which the first connection portion 41 is coupled to the second connection portion 42 and which extends across the third housing component 23, the fourth housing component 24, and the fifth housing component 25, wherein said coupling portion 45, guided in a corresponding manner in the housing by guide elements 47, assumes mutually differing alignments. This means in particular that a portion of the first coupling portion 45 that is disposed in one of the intermediary housing components 23, 24, and 25, in the direction parallel to the vertical axis 27 has an alignment that does not overlap with a portion of the first coupling portion 45 in other intermediary housing component 24, 25, or 23. In short: a first portion of the first coupling portion 45 does not lie in the alignment of a second portion of the first coupling portion when the first and the second portion are disposed in different intermediary housing components 23, 24, and 25.

The first connection portion 41 by means of a first connecting means configured as a carabiner 61 is fastened to a first connection region 211 of the first housing component 21 by way of a first connection location configured as an eyelet screw 51, wherein the first connection region 211 is provided by the cover plate of the first housing component 21.

A shackle can also be used instead of the carabiner 61.

The second connection portion 42 by means of a second connecting means (a braided line of the same type as the flexible sling gear according to the invention used here) configured as a further flexible sling gear 62 is fastened to a second connection region 221 of the second housing component 22 by way of two connection locations configured as deck plates 52 (also referred to as eye plates, eyelet plates, or mast plates).

The further flexible sling gear 62 not only provides the connection function but also the function of a tensile force limiter 49 in that said flexible sling gear 62 deflects tensile forces that in the direction of the vertical axis 27 act on the braided line 40 from the vertical axis direction and thus causes a yielding in the direction of the vertical axis 27, said yielding being a function of tension.

The second connection region 221 is provided by a shell region of the wall of the second housing component 22, said shell region being concentric with the vertical axis 27 and in the direction of the vertical axis being disposed so as to be spaced apart by a fastening region 223 of the second housing component 22 and a predetermined breaking region 222 of the second housing component that is disposed between the fastening region 223 and the second connection region 221.

The fastening region 223 of the second housing component 22 is provided at least by the lower collar and the lower shell region which is concentric with the vertical axis 27 and adjoins the lower collar and in the direction of the vertical axis in terms of height does not extend beyond the thickness of the fastening plate 31.

The predetermined breaking region 222 of the second housing component in the direction of the vertical axis that faces away from the foundation 30 adjoins the fastening region 223 and is provided by that shell region of the housing component 22 that is concentric with the vertical axis 27 and is located between the fastening region 223 and the second connection region 221.

In the event of an impact of a vehicle on the housing 20 in an impact region above the fastening region 223, a compressive force on the housing 20 is exerted so as to be substantially perpendicular to the vertical axis 27. The housing 20 cannot yield to said compressive force, at least not in the fastening region 223. Therefore, a shear stress is formed between the impact region and the fastening region 223, said shear stress being highest in the proximity of the fastening region 223 which is relatively small in comparison to the impact region and in which a resistance counter to the compressive force builds up. Therefore, shearing-off of a main region 20′ of the housing 20 from the fastening region 223 of the housing 20 that consequently remains on the foundation arises most likely in the predetermined breaking region 222 located according to the invention. Since the braided line which is intended to secure a cohesion of the housing components 21, 22, 23, 24, 25 is fastened in a second connection region 221 which is comprised by the main region 20′ that is subjected to any potential shearing, the cohesion even of the sheared-off housing components 21, 23, 24, 25, as well as partially 22, remains assured even in the case of shearing-off that has actually taken place.

In order for the data-processing installation 15, which in the direction of the vertical axis is located so as to be level with the predetermined breaking region 222, to be secured against being released from the sheared-off composite of the main region 20′, the data-processing installation 15 is also connected to a housing component region of the main region by way of a flexible sling gear. In this case, the data-processing installation 15 is latched to the further flexible sling gear 62 by means of a carabiner.

No traffic monitoring installations 11, 12, 13 and data-processing installation 15 are illustrated in FIGS. 2, 3, 4, 5, and 6, which form the illustrations for explaining the following exemplary embodiments, in order to improve clarity and to focus the contents illustrated on the feature signifying the characterizing part of the invention.

### Second Exemplary Embodiment

The second exemplary embodiment of a traffic monitoring installation 10 according to the invention in FIG. 2 is illustrated in a schematic cross-sectional view along the vertical axis 27 of the housing 20, wherein the cross-sectional plane lies in the plane of the detection direction of the traffic monitoring installations, this being visualized by means of the detection direction symbol 19 which symbolizes a detection direction lying in the illustration plane.

The second exemplary embodiment differs from the first exemplary embodiment substantially on account of three features: a) the provision of an intermediate piece 29 that serves as a predetermined breaking point, b) the arrangement of the first coupling portion 45 in the housing 20, and c) the configuration of the tensile force limiter 49.

An intermediate piece 29 which at the same time forms the lowermost housing component (that housing component that of all housing components on the vertical axis 27 is disposed closest to the foundation 30) and serves as a predetermined breaking point according to the invention is thus provided by the traffic monitoring arrangement 10 of this second exemplary embodiment. The lower, second housing component 22 as the second lowermost housing component, which according to the invention provides the second connection region 221, is fastened indirectly to the foundation 30 by way of said intermediate piece 29.

The lower side of the intermediate piece 29 that faces the foundation 30 is provided by a base plate 33 of the intermediate piece 29, said base plate 33 forming a fastening region 293 of the intermediate piece 29 and the internal side thereof that faces away from the foundation 30 having an encircling groove 34 that directly adjoins the internal face of the shell region of the intermediate piece 29 and is concentric with the vertical axis 29. The shear stresses in the event of an impact accumulate on the internal edge of the groove 34 that points toward the shell region, so that the sub-region of the shell region of the intermediate piece 29 that directly adjoins the groove 34 can be considered as the predetermined breaking region 292 of the intermediate piece 29, said predetermined breaking region 292 per se being the predetermined breaking point of the traffic monitoring installation 10.

This is because the second connection portion 42 of the braided line 40 as well as the connection location 52 which is configured as the tensile force limiter 49 and which by means of threaded bolts 28a and nuts 28b is fastened to the second housing component 22, more specifically to the lower-side collar of said housing component 22 that provides the second connection region 221, are situated in the second housing component 22.

An alternative description of these conditions can be followed by means of FIG. 2′, the latter being an illustration of FIG. 2 in fragments of the traffic monitoring arrangement 10 that is restricted to the lower housing component as well as to the components of the foundation 30 and of the second lowermost housing component that are connected directly thereto. The connection location 52 by way of the threaded bolts 28a and the nuts 28b is indeed not only fastened to the second lowermost but also to the lowermost housing component which, as opposed to the preceding description pertaining to FIG. 2, according to FIG. 2′ can also be considered to be the second housing component 22 to which, on the side facing away from the foundation 30, the third intermediary housing component 25 is connected according to FIG. 2′, said third intermediary housing component 25 in FIG. 2 having been considered to be the second housing component 22. Accordingly, according to FIG. 2′, the second connection region 221 by the upper-side collar of the second housing component 22, the fastening region 223 by the lower-side base plate 33 of the second housing component 22, and the predetermined breaking region 222 by the shell region of the second housing part 22 that in the direction of the vertical axis is disposed between the fastening region 223 and the second connection region 221.

As can be concluded by means of FIG. 2, the arrangement of the first coupling portion 45 in the housing 20 is characterized in that said arrangement is performed substantially along a straight connecting line between the first connection portion 41 and the second connection portion 42, said connecting line being parallel to the vertical axis 27. A first sub-portion of the first coupling portion 45 herein is in each case disposed in the alignment, parallel to the vertical axis 27, of a second sub-portion of the first coupling portion 45, wherein the first sub-portion and the second sub-portion are disposed in different intermediary housing components 23 and 24.

The second connection location 52 which acts as a tensile force limiter 49, is separately illustrated in an oblique view in FIG. 2a. Said second connection location 52 is composed of two plate portions 55 and 57 that are mutually contiguous in an orthogonal manner, and has been produced by bending a single planar plate from stainless steel, having a thickness of 4 mm. A first plate portion 55 serves as a connector portion 55 for fastening the second connection location 52 to the second connection region 221 and to this end has four continuous connecting openings 56 which serve for receiving the shank of the threaded bolts 28a. A second plate portion 57 in the form of a lug serves as an attaching portion 57 for fastening the second connection portion 42 by means of a carabiner 62 (FIG. 2 and FIG. 2′) and to this end has an attaching opening 58 which is provided for engaging with the carabiner 62 in a reciprocating manner.

The first plate portion 55 moreover has two tear seam structures 59 which have been incorporated in the plate by etching or laser cutting and delimit a plate region of the first plate portion 55 that ends in the second plate portion 57. Tearing of said tear seam structures 59 takes place when a tensile force acting in the direction of the vertical axis 27 on the attaching portion 57 exceeds a limit tensile force. The tearing herein is preceded by a deflection of the second plate portion 57 in relation to the first plate portion 55 in a manner at least partially parallel to the vertical axis 27. A further deflection of this type takes place with tearing and after tearing, wherein the connection between the first connection region 221 and the second connection region 222 established by way of the flexible sling gear 40 is maintained in a tensile-force-limited manner on account of the yielding of the second tensile-force-limiting connection location 52.

In the case of this exemplary embodiment, the connection location 52 is disposed between the screw heads of the screws 28a and the lower-side collar of the second lowermost housing component, wherein, on account of the circumstance that the screws 28a and the nuts 28b are contemporaneously connecting means for connecting the second lowermost housing component to the lowermost housing component and fastening means for fastening the connection location 52 to the lower-side collar of the second lowermost housing component, as described, the ambivalent understanding is permissible that the second housing component 22 can be provided the second lowermost housing component (FIG. 2) as well as the lowermost housing component (FIG. 2′).

The same applies to the case of an alternative arrangement (not illustrated) of the connection location 52 between the nuts 28b and the upper-side collar of the lowermost housing component. In a manner analogous to the afore-described case, it applies in this case that the screws 28a and the nuts 28b are contemporaneously connecting means for connecting the second lowermost housing component to the lowermost housing component and fastening means for fastening the connection location 52 to the upper-side collar of the lowermost housing component. The same ambivalent understanding as in the afore-described case that the second lowermost as well as the lowermost housing component can correspond to the second housing component according to the invention is thus also permissible in this case.

### Third Exemplary Embodiment

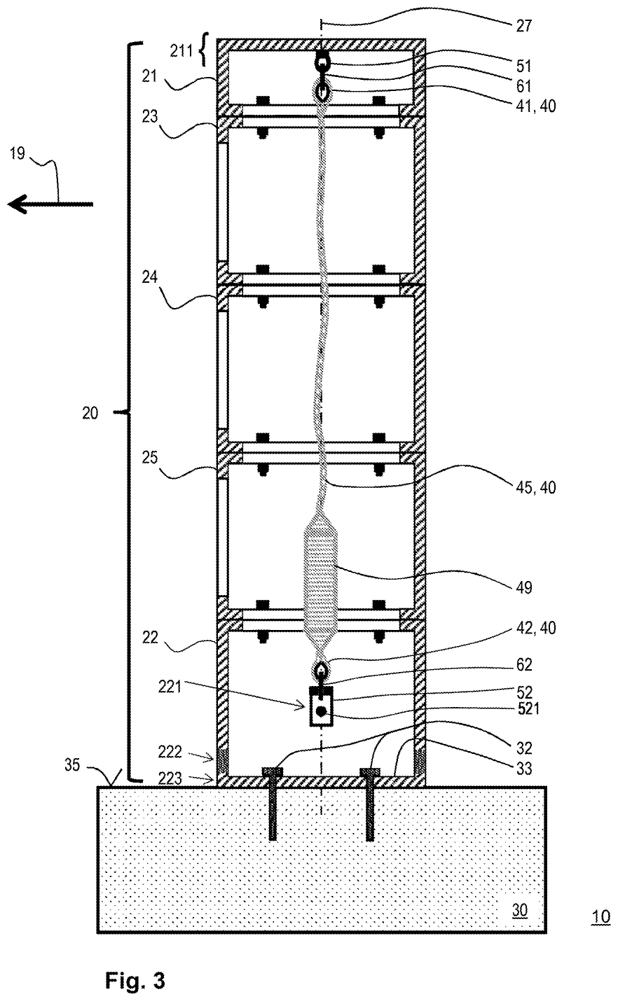

The third exemplary embodiment of a traffic monitoring arrangement 10 according to the invention in FIG. 3 is illustrated in a schematic cross-sectional view along the vertical axis 27 of the housing 20, wherein the cross-sectional plane lies in the plane of the detection direction of the traffic monitoring installations, this being visualized by means of the detection direction symbol 19 which symbolizes a detection direction lying in the illustration plane.

The third exemplary embodiment differs from the first exemplary embodiment substantially on account of three features: a) the configuration second housing component 22, b) the arrangement of the first coupling portion 45 in the housing 20, and c) the configuration of the tensile force limiter 49.

By contrast to the first exemplary embodiment, the second housing component 22 on the lower side thereof that faces the foundation 30 has a base plate 33 which bears on the foundation 30 and has a plurality of continuous fastening openings through which the shanks of the screws 32 for fastening the housing 20 to the foundation 30 are guided. The shell region of the housing component 22 which adjoins the base plate 33 so as to be concentric with the vertical axis 27 and which in the direction of the vertical axis is delimited to the thickness of the base plate, forms the fastening region 223 of the housing component 22. The second connection region 221 is provided by that shell region of the housing component 22 in which the fastening means 521 (in this case a screw) for fastening the second connection location 52 (in this case a fastening angle 52 having an attaching opening for engaging a carabiner 62 which in turn latches in the cringle of the eye 42 as a second connection portion of the braided line 40) engages and which in the direction of the vertical axis 27 is spaced apart from the fastening region 223 by a shell region which encircles the housing component 22 and is configured as the predetermined breaking region 222.

Said predetermined breaking region 222 has a second housing component material which is more brittle than a first housing component material in regions of the second housing component 22 outside the predetermined breaking region 222. For example, the second housing component material has a finer-grain microstructure than the first housing component material, said finer-grain microstructure having been generated in the first housing component material by thermal and/or mechanical treatment in the predetermined breaking region 222, for example. On the other hand, the second housing component material can differ from the first housing component material also in chemical terms, this having been generated by the effect of an embrittlement agent, for example hydrogen, on electrolytic copper Cu-ETP or martensitic steel, on the first housing component material in the predetermined breaking region 222. Finally, the housing component 22 can also be in three parts, wherein the predetermined breaking region 222 as a predetermined breaking ring can also be made separately from a lower housing component portion which comprises the fastening region 223 including the base plate 33, and from the upper housing component portion which comprises the second connection region 221, and be made from a second housing component material which is entirely different from the first housing component material of the lower and the upper housing component portion. In the course of the production, the predetermined breaking ring may have been inserted between the lower and the upper housing component portion by means of soldering/brazing, for example.

As can be concluded by means of FIG. 3, the arrangement of the first coupling portion 45 in the housing 20 is characterized in that said arrangement takes place substantially along a straight connecting line between the first connection portion 41 and the second connection portion 42, said connecting line being parallel to the vertical axis 27. A first sub-portion of the first coupling portion 45 herein is in each case disposed in the alignment, parallel to the vertical axis 27, of a second sub-portion of the first coupling portion 45, wherein the first sub-portion and the second sub-portion are disposed in different intermediary housing components 23 and 24, 23 and 25, and/or 24 and 25.

In this third exemplary embodiment, a strap fall attenuator 49 which as part of the flexible sling gear is disposed between the first coupling portion 45 and the second connection portion 42 serves as the tensile force limiter, said first coupling portion 45 and said second connection portion 42 being linked to one another by way of the strap fall attenuator 49. This arrangement alternatively permits the consideration that the strap fall attenuator 49 is either part of the first coupling portion 45 or part of the second connection portion 42.

### Fourth Exemplary Embodiment

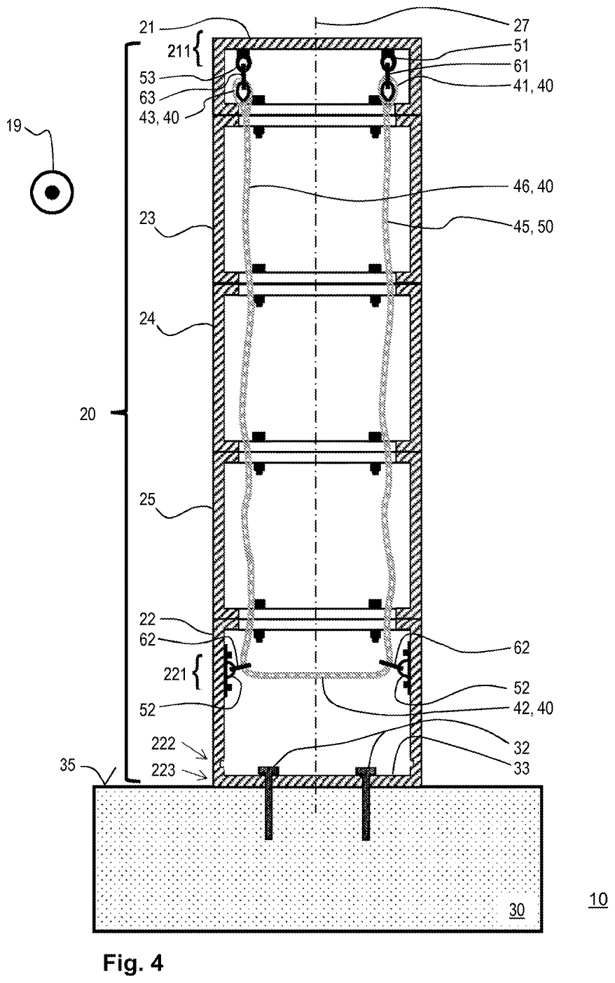

The fourth exemplary embodiment of a traffic monitoring arrangement 10 according to the invention in FIG. 4 is illustrated in a schematic cross-sectional view along the vertical axis 27 of the housing 20, wherein the cross-sectional plane lies so as to be perpendicular to the detection direction of the traffic monitoring installations (not illustrated), this being visualized by means of the detection direction symbol 19 which symbolizes a detection direction that is directed out of the illustration plane.

The fourth exemplary embodiment differs from the first exemplary embodiment substantially on account of three features: a) the configuration second housing component 22, b) the configuration and arrangement of the braided line 40 in the housing 20, and c) the absence of a tensile force limiter 49.

The configuration of the second housing component 22 is initially similar to that of the third exemplary embodiment but with the difference that the determined breaking region 222 is not provided by a material microstructure or a material that is different from the remaining housing component 22 but by a material deficit in the shell of the housing component 22, said material deficit having been generated by a groove incorporated in the internal wall of the shell.

The configuration and the arrangement of the braided line 40 in the housing 20 is of such a manner that the braided line 40 provides the connection between the first uppermost housing component 21 and the second lowermost housing component 22 multiple times, in this case in an exemplary manner twice, wherein a triple or quadruple connection is also possible. Specifically, the first connection portion 41 is a first end portion of the braided line 40 that by way of a carabiner 61 is fastened to an eye screw 51 which is screwed into the cover plate of the first housing component 21. A third connection portion 43 of the braided line 40 is provided by a second end portion of the braided line 40 and by way of a carabiner 63 is fastened to an eye screw 53 which is likewise screwed into the cover plate of the first housing component 21. The second connection portion 42 of the braided line 40 is provided by a central portion of the braided line which by way of two mutually opposite connection locations 52 which are in each case provided by a cover plate 52, fastened to the second connection region 221 of the second housing component 22 which is provided by the wall region 221 of the shell of the housing component 22, which along the vertical axis 27 is spaced apart from the fastening region 223 by the predetermined breaking region 222.

The first coupling portion 45 of the braided line 40 that connects the first connection portion 41 to the second connection portion 42 is disposed in the intermediary housing components 23, 24, and 25.

A second coupling portion 46 of the braided line 40 that connects the third connection portion 43 to the second connection portion 42 is likewise disposed in the intermediary housing components 23, 24, 25.

On account thereof, the profile of the braided line 40 in the housing 20 is imparted the shape of a letter U which is upright in relation to a direction that along the vertical axis points away from the foundation.

On account of this multiple linking of the first housing component 21 and the second housing component 22, the tensile forces that in the event of a breakage act on the braided line 40 can be distributed to two parallel first and second coupling portions 45 and 46 of the braided line so that a tensile force limiter can be dispensed with.

### Fifth Exemplary Embodiment

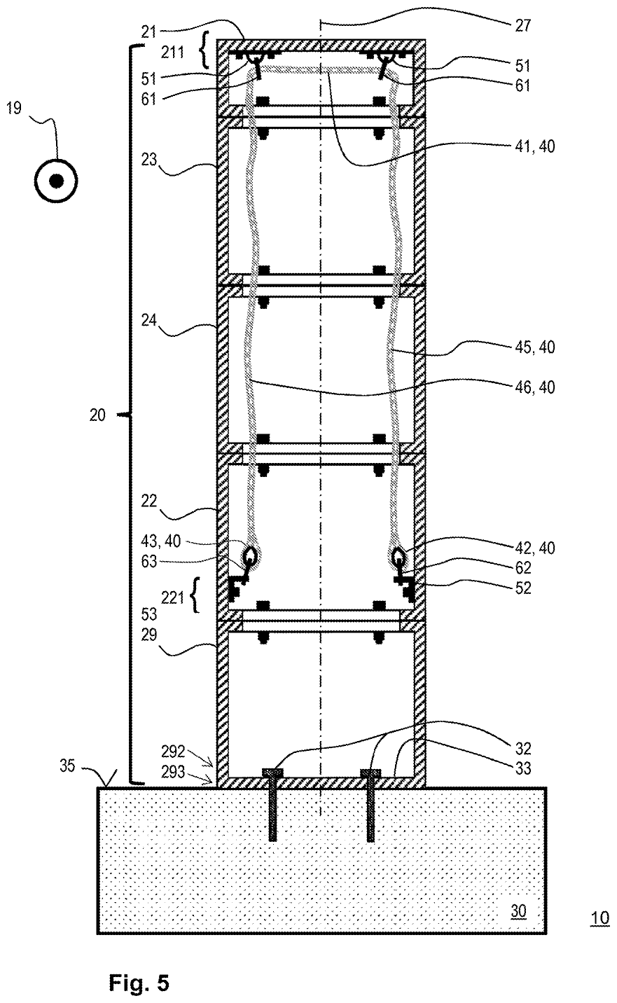

The fifth exemplary embodiment of a traffic monitoring arrangement 10 according to the invention in FIG. 5 is illustrated in a schematic cross-sectional view along the vertical axis 27 of the housing 20, wherein the cross-sectional plane lies so as to be perpendicular to the detection direction of the traffic monitoring installations (not illustrated), this being visualized by means of the detection direction symbol 19 which symbolizes a detection direction that is directed out of the illustration plane.

The fifth exemplary embodiment differs from the fourth exemplary embodiment substantially on account of three features: a) the arrangement and the configuration second housing component 22, b) the configuration and the arrangement of the braided line 40 in the housing 20, and c) the configuration of a predetermined breaking region 292 in the intermediate piece 29.

In the case of said fifth exemplary embodiment the second housing component 22 is not the lowermost housing component but the second lowermost housing component of the housing 20 that by means of an intermediate piece 29 which is likewise a housing component of the housing 20 is fastened to the foundation 30. The intermediate piece 29 per se has a base plate 31 that faces away from the housing component 22 and faces the foundation 30, said base plate 31 having openings through which the shanks of fastening screws 32 for engaging in the foundation 30 are guided.

The intermediate piece 29 is the predetermined breaking point according to the invention of said fifth exemplary embodiment of the traffic monitoring arrangement 10 according to the invention.

As compared to the fourth exemplary embodiment, the arrangement of the braided line 40 is reversed, specifically in that said arrangement has the shape of a letter U which in relation to a direction along the vertical axis pointing away from the foundation is mirrored in a manner perpendicular to the vertical axis, that is to say has the shape of an inverted U.

Specifically, the first connection portion 41 is provided by a central portion of the braided line 40. Said central portion by way of in each case latching carabiners 61 is in each case fastened to the first housing component 21 by means of two cover plates 51 which serve as first connection locations and which in relation to an imaginary plane which in a manner perpendicular to the illustration plane comprises the vertical axis 27 are fastened to mutually opposite sides of the cover plate of the first housing component 21.

The second connection portion 42 is provided by a first end portion of the braided line 40 which by means of a carabiner 62 is fastened to the housing wall of the second housing component 22 by way of a second connection location 52 which comprises a fastening angle having an attaching opening for latching the carabiner 62.

A third connection portion 43 is provided by a second end portion of the braided line 40 which by means of a carabiner 63 is fastened to the housing wall of the second housing component 22 by way of a third connection location 53 which comprises a fastening angle having an attaching opening for latching the carabiner 63.

The first coupling portion 45 of the braided line 40 that connects the first connection portion 41 to the second connection portion 42 is disposed in the intermediary housing components 23, 24, and 25.

A second coupling portion 46 of the braided line 40 that connects the third connection portion 43 to the second connection portion 42 is likewise disposed in the intermediary housing components 23, 24, and 25.

The intermediate piece 29 in turn finally has a fastening region 293 which in terms of the extent thereof parallel to the vertical axis 27 is restricted to the thickness of the base plate 33 of the intermediate piece 29. The intermediate piece likewise has a predetermined breaking region 292 where the shear stresses in the event of an impact are concentrated in such a manner that shearing-off takes place in the predetermined breaking region 292. As opposed to exemplary embodiments two, three and four, this predetermined breaking region neither in terms of structure nor material is defined in the sense of a weakening that has intentionally been incorporated by the other wall regions of the shell. In a manner similar to the first exemplary embodiment, said predetermined breaking region is defined in that said predetermined breaking region in the direction parallel to the vertical axis pointing away from the foundation directly adjoins the defined fastening region 293.

A configuration of the fastening region and of the predetermined breaking region of the lowermost housing component in the first exemplary embodiment in a manner analogous to the intermediate piece 29 of this exemplary embodiment is possible in the same manner in said first exemplary embodiment.

Both the fourth as well as the fifth exemplary embodiment can be modified with a view to two I-shaped braided lines being used instead of a single U-shaped braided line 40. FIGS. 4 and 5 to this end would have to be modified such that instead of said central portions (the second connection portion 42 in the fourth exemplary embodiment, the first connection portion 41 in the fifth exemplary embodiment), end portions of different braiding lines would exist according to the pattern of the already described end portions which are fastened to the corresponding connection locations on the second housing component 22 (fourth exemplary embodiment) and on the first housing component 21 (fifth exemplary embodiment), respectively.

### Sixth Exemplary Embodiment

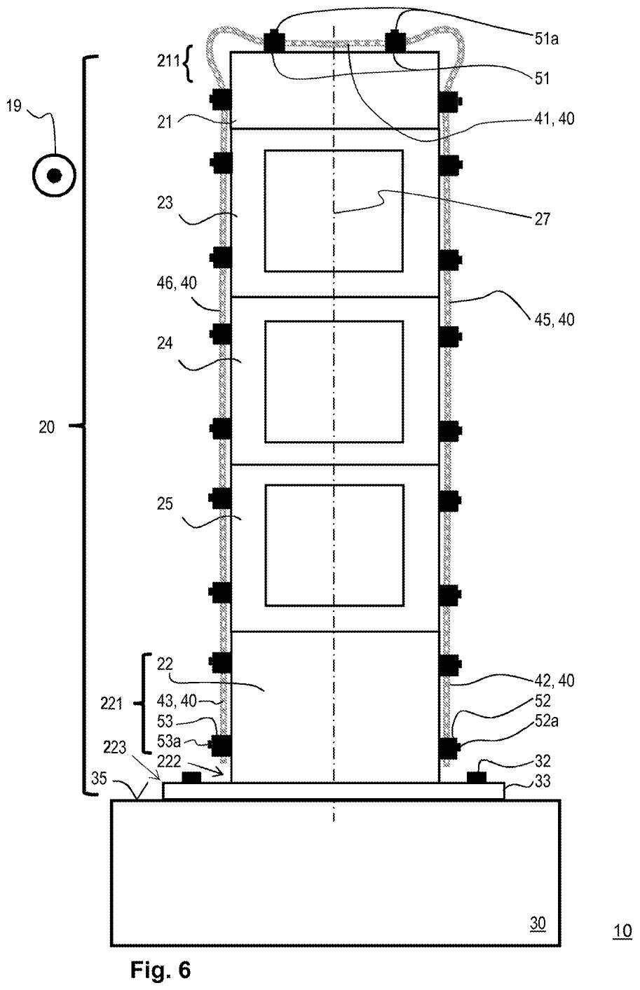

The sixth exemplary embodiment of a traffic monitoring arrangement 10 according to the invention in FIG. 6 is illustrated in a schematic external view of the housing 20, wherein the illustration plane lies so as to be perpendicular to the detection direction of the traffic monitoring installations (not illustrated), this being visualized by means of the detection direction symbol 19 which symbolizes a detection direction that is directed out of the illustration plane.

The sixth exemplary embodiment differs from the fifth exemplary embodiment substantially substantially on account of three features: a) the flexible sling gear 40 is is not disposed in the housing 20 but outside the housing on the housing, b) the base plate of the lowermost second housing component 22 is configured as an external collar, and c) the flexible sling gear per se.

In particular, a chain 40 having links from stainless steel, which is reinforced by a plastics material cladding, is used instead of the textile rope of the preceding exemplary embodiment.

Portions 41, 42, 43, 45, and 46 of the chain and the arrangement of said chain in terms of a fastening to the first housing component 21 and the second housing component 22 correspond to that of the fifth exemplary embodiment with the difference that the arrangement and the fastening is not performed in the housing 20 but outside the housing 20.

In order for the chain to be fastened to the housing 20, connection locations 51, 52, and 53 are provided which are U-shaped and on the base thereof, which in relation to the end faces of the legs is oriented so as to face away from the housing wall, have in each case a breakthrough for receiving a shank of in each case one screw 51a, 52a, and 53a, said screws 51a, 52a, and 53a being guided through a chain-link that is disposed between the legs of the respective connection locations and engaging in an internal thread of the respective housing component sub-wall of the respective housing component 21 or 22.

Further connection locations of the same type (not referenced) serve for fastening the chain 40 in portions to the intermediary housing components 23, 24, and 25.

The base plate 33, configured as an outwardly directed collar, of the lowermost housing component serves for fastening the lowermost housing component 22 to the foundation 30, said base plate 33 contemporaneously providing the fastening region 223 according to the invention. The predetermined breaking region 222 of the housing component 22 in the direction facing away from the foundation 30 adjoins the internal edge of the housing wall having the external collar 33, said housing wall being parallel to the vertical axis 27.

All of the exemplary embodiments can be modified with a view to the braided line/chain 40 along the longitudinal axis thereof being subdivided into a plurality of parts which in turn on the end portions have connection portions for fastening to the intermediary housing component(s) 23, 24, and/or 25 in/on which the respective connection portion of the braided line/chain 40 is disposed. On account of said singularization, the property of an originally intermediary housing component 23, 24, and/or 25 changes such that said originally intermediary housing component 23, 24, and/or 25 acts in the sense of the invention as one of a plurality of first housing components and/or one of a plurality of second housing components.

Such a piecewise multiple application of the principle according to the invention in series across a plurality of pairs of indirectly or directly adjacent housing components can be expedient when a single, comparatively long flexible sling gear 40 cannot or is not to be installed in its entirety on/through the housing, for example as a result of a deficiency in terms of space in the housing or of cost savings on the housing.

While reference has at all times been made in the exemplary embodiments to a foundation 30 as the landing component of the traffic monitoring installation, the foundation 30 in each exemplary embodiment can be replaced by a landing component of the housing 20. Such a landing component can likewise be a housing component of the housing 20 that conjointly with the remaining housing components 21, 22, 23, 24, and optionally 25, encloses a common interior space of the housing 20.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A traffic monitoring arrangement having a housing which has a first housing component and at least one second housing component, wherein the first housing component and the second housing component are connected to one another by at least one flexible sling gear, and the traffic monitoring arrangement has at least one predetermined breaking point which in relation to a local connection region which is provided by the second housing component and to which the flexible sling gear is fastened is located on a side of the traffic monitoring arrangement that faces away from the first housing component.

2. The traffic monitoring arrangement as claimed in claim 1, wherein a landing region for landing the traffic monitoring arrangement in the ground, wherein the landing region in relation to the predetermined breaking point is disposed on a side that faces away from the local connection region.

3. The traffic monitoring arrangement as claimed in claim 1, wherein the traffic monitoring arrangement has a landing region for landing the traffic monitoring arrangement in the ground; the first housing component and the second housing component are disposed on a common vertical axis of the traffic monitoring arrangement that ends in the landing region; and the local connection region in the direction of the vertical axis is spaced apart from the landing region by the at least one predetermined breaking point.

4. The traffic monitoring arrangement as claimed in claim 1, wherein the traffic monitoring arrangement has a landing region for landing the traffic monitoring arrangement in the ground, wherein the landing region is provided by a landing component which is configured as a foundation of the traffic monitoring arrangement or a landing component of the housing; the first housing component and the second housing component belong to housing components of the housing that are disposed on top of one another on a common vertical axis of the housing that ends in the landing component, the first housing component in relation to the second housing component being disposed on the side of the second housing component that faces away from the landing component; the second housing component is fastened directly or indirectly, that is to say so as to be spaced apart from the landing component by at least one intermediate piece, to the landing component; and the local connection region in the direction of the vertical axis is spaced apart from the landing component by the at least one predetermined breaking point, wherein the predetermined breaking point is provided by the intermediate piece (29), or a predetermined breaking region of the second housing component, said predetermined breaking region being disposed between the local connection region and a fastening region of the second housing component that is fastened to the landing component.

5. The traffic monitoring arrangement as claimed in claim 1, wherein the housing has at least one intermediary housing component which, on a vertical axis of the traffic monitoring arrangement on which the first housing component and the second housing component are also disposed, is disposed between the first housing component and the second housing component, the first housing component being connected to the second housing component by way of said intermediary housing component; and the flexible sling gear in the intermediary housing component or outside the intermediary housing component is at least in portions disposed in an alignment of the intermediary housing component which, proceeding from the intermediary housing component, extends so as to be perpendicular to the vertical axis.

6. The traffic monitoring arrangement as claimed in claim 1, wherein the flexible sling gear has a first connection portion which by way of at least one first connection location is fastened to a first connection region of the first housing component, and at least one second connection portion which by way of at least one second connection location is fastened to the local connection region as the second connection region of the second housing component, wherein the first connection location is configured as a first coupling which is provided by a first coupling portion of the first housing component or by a first coupling component which is made independently of the first housing component and which is, in particular releasably, fastened to the first housing component, and/or the second connection location is configured as a coupling which is provided by a coupling portion of the second housing component or by a coupling component which is made independently of the second housing component and which is, in particular releasably, fastened to the second housing component.

7. The traffic monitoring arrangement as claimed in claim 1, wherein the flexible sling gear has a first connection portion which by way of at least one first connection location is fastened to a first connection region of the first housing component, and at least one second connection portion which by way of at least one second connection location is fastened to the local connection region as the second connection region of the second housing component, wherein of the flexible sling gear at least the first connection portion and the second connection portion are disposed either in the interior space of the housing or outside the housing, wherein the interior space in turn at least in portions is delimited by housing walls of the housing components, the first connection portion is formed by at least one first housing wall portion of the first housing component, and the second connection region is formed by at least one second housing wall portion of the second housing component.

8. The traffic monitoring arrangement as claimed in claim 1, wherein the traffic monitoring arrangement has a foundation for landing the traffic monitoring arrangement in the ground, the first housing component and the second housing component belong to housing components of the housing that are disposed on top of one another on a common vertical axis of the housing that ends in the foundation, the first housing component in relation to the second housing component being disposed on the side of the second housing component that faces away from the landing component; the second housing component is fastened to the landing component; and the local connection region in the direction of the vertical axis is spaced apart from the landing component by the at least one predetermined breaking point, said predetermined breaking point being provided by a predetermined breaking region of the second housing component, said predetermined breaking region being disposed between the local connection region and a fastening region of the second housing component that is fastened to the landing component, wherein the second housing component comprises at least one housing wall that is aligned so as to be parallel to the vertical axis; the fastening region of the second housing component is provided by a base plate which bears on a bearing face of the foundation and which is connected to the at least one housing wall; the predetermined breaking region of the second housing component is provided by a first housing wall portion of the at least one housing wall that, in a manner parallel to the vertical axis, is spaced apart from the bearing face of the foundation by at least the thickness of the base plate in the connector region of the latter to the at least one housing wall; and finally the second connection region of the second housing component is provided by a second housing wall portion of the at least one housing wall that in the direction facing away from the foundation adjoins the first housing wall portion in a manner parallel to the vertical axis and includes the second connection location or means for fastening the second connection location.

9. The traffic monitoring arrangement as claimed in claim 1, wherein the flexible sling gear has at least one tensile force limiter, or is connected to the first housing component and/or the second housing component by way of at least one tensile force limiter.

10. The traffic monitoring arrangement as claimed in claim 9, wherein the traffic monitoring arrangement has a landing region for landing the traffic monitoring arrangement in the ground; the first housing component and the second housing component are disposed on a common vertical axis of the traffic monitoring arrangement that ends in the landing region; the flexible sling gear has a first connection portion which by way of at least one first connection location is fastened to a first connection region of the first housing component, and at least one second connection portion which by way of at least one second connection location is fastened to the local connection region as the second connection region of the second housing component, wherein the first/the second connection location is at least in part formed by a metallic plate which has a first plate portion which is fastened to the first/the second connection region, and a second plate portion to which the first/the second connection portion is fastened, wherein the metallic plate acts as the tensile force limiter in that said metallic plate is configured and in relation to the vertical axis is oriented in such a manner that a tensile force that is exerted on the second plate portion so as to be at least partially parallel to the vertical axis deflects the second plate portion in relation to the first plate portion in a manner at least partially parallel to the vertical axis.

11. The traffic monitoring arrangement as claimed in claim 1, wherein flexible sling gear is provided by a lashing which has a plurality of elongate fibers that are intertwined by twisting or braiding.

12. The traffic monitoring arrangement as claimed in claim 1, wherein the traffic monitoring arrangement has a landing region for landing the traffic monitoring arrangement in the ground; the first housing component and the second housing component are disposed on a common vertical axis of the traffic monitoring arrangement that ends in the landing region; and at least one first sub-portion of the flexible sling gear that is disposed in a first intermediary housing component which is disposed between the first housing component and the second housing component is disposed outside an alignment, running parallel to the vertical axis, of at least one second sub-portion of the flexible sling gear that is disposed in a second intermediary housing component which is disposed between the first housing component and the second housing component.

13. The traffic monitoring arrangement as claimed in claim 1, wherein a plurality of different first sub-portions of the flexible sling gear that are separated from one another by different second sub-portions of the flexible sling gear that are disposed in the first housing component and the second housing component and/or are fastened to said first housing component and said second housing component, are disposed in one and the same intermediary housing component which is disposed between the first housing component and the second housing component.

14. The traffic monitoring arrangement as claimed in claim 1, wherein the predetermined breaking point is provided by a first wall portion of a housing component, the first thickness of said first wall portion being less than the second thickness of a second wall portion of the same or of another housing component, wherein the second wall portion in relation to the first wall portion is disposed on a side of the housing that faces away from the local connection region.

15. The traffic monitoring arrangement as claimed in claim 1, wherein a third housing component of the housing, said third housing component being disposed on a side of the first housing component that faces away from the second housing component, and by a plurality of flexible sling gears of which a first flexible sling gear is said first flexible sling gear by way of which the first housing component and the second housing component are connected to one another, and a second flexible sling gear is a further flexible sling gear by way of which the first housing component and the third housing component are connected to one another.
